(19) United States
(12) Patent Application Publication
(10) Pub. No.: US 2002/0180788 A1
(43) Pub. Date: Dec. 5, 2002

(54) Method of video displaying for E-mails

(76) Inventor: Hsiang Min Wu, Taipei City (TW)

Correspondence Address: WU Hsiang Min, PO Box 82-144, TAIPEI, TW

(21) Appl. No.: 09/870,633

(22) Filed: Jun. 1, 2001

(51) Int. Cl. G09G 5/00

(52) U.S. Cl. 345/752

(57) ABSTRACT

The present invention relates to a method of video displaying for E-mails by employing video compression technique to compress the video film into data having smaller bytes. The data is then attached to the E-mail. A user receiving the E-mail clicks onto the E-mails, the film will be automatically displayed within the E-mail format without user's clicking onto an attached executable file or without linking to Internet server to download a video film. The user can watch the video film directly and instantaneously.

### BACKGROUND OF THE INVENTION

(a) Field of the Invention

The present invention relates to a method of video displaying for E-mails.

(b) Description of the Prior Art

Electronic Mail or E-mail is useful in transmitting text, pictures, and graphics and files with video films. As a result, advertising E-mail and electronic newsletters with advertising are developed. Generally, these emails are operated as shown in FIG. 1. The E-mail sender first prepared the advertising E-mails and the sender can be the corporation, organizations, institutions, schools, professionals, or electronic newsletter.

There are two conventional methods for E-mail senders to send E-mails with video films.

One method is to include a link address or display window in the E-mail. In order to watch the video after receiving and opening the E-mail, the recipient has to wait for some time for the download the video file from remote server through the Internet. When the bandwidth of Internet connection is not sufficient or steady, the quality of the video presentation will be influenced. In this conventional method, the effectiveness of advertising is not significant because of the time required for the download and because of the unstable video presentation quality.

The other method is to include a video file as an attachment in the E-mail. Therefore, the recipient does not have to wait for the download of video file from the Internet. However, the recipient needs to click and open the attached file after receiving the E-mail. In this conventional method, the user acts as a pro-active party to browse the attached mail. If the user does not wish to view the attachment, the objective of the attachment will not be attained.

### SUMMARY OF THE INVENTION

The present invention relates to a method of video displaying for E-mails by employing video compression technique to compress the video film into data having smaller bytes. The data is then attached to the E-mail. A user receiving the E-mail clicks onto the E-mail, the video film will be automatically displayed within the E-mail format without clicking onto an executable attachment file or linking to the Internet to download the video file from a remote server. The user can directly watch the video film on the Email instantaneously when it is opened.

The object of the present invention is to provide a method of video displaying for E-mails with video films, allowing an user at the receiving end to increase rate of browsing, comprising the steps of providing a video film; preparing an E-mail and sending the E-mail to an user (recipient); receiving the E-mail by the user (recipient); and determining the presence of a video player software, wherein, if the video player software is not available in the user's computer, automatically downloading the video player software from an Internet server; if the video player software is available, broadcasting the film immediately.

Another object of the present invention is to provide a method of video displaying for E-mails, wherein the video film producer can work together with corporations, organizations, institutions, schools, professionals, or electronic newsletters to provide commercial advertisement, movie previews, teaching lessons, documentary films, news, MTV, for instant viewing.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the utilization of a conventional E-mail.

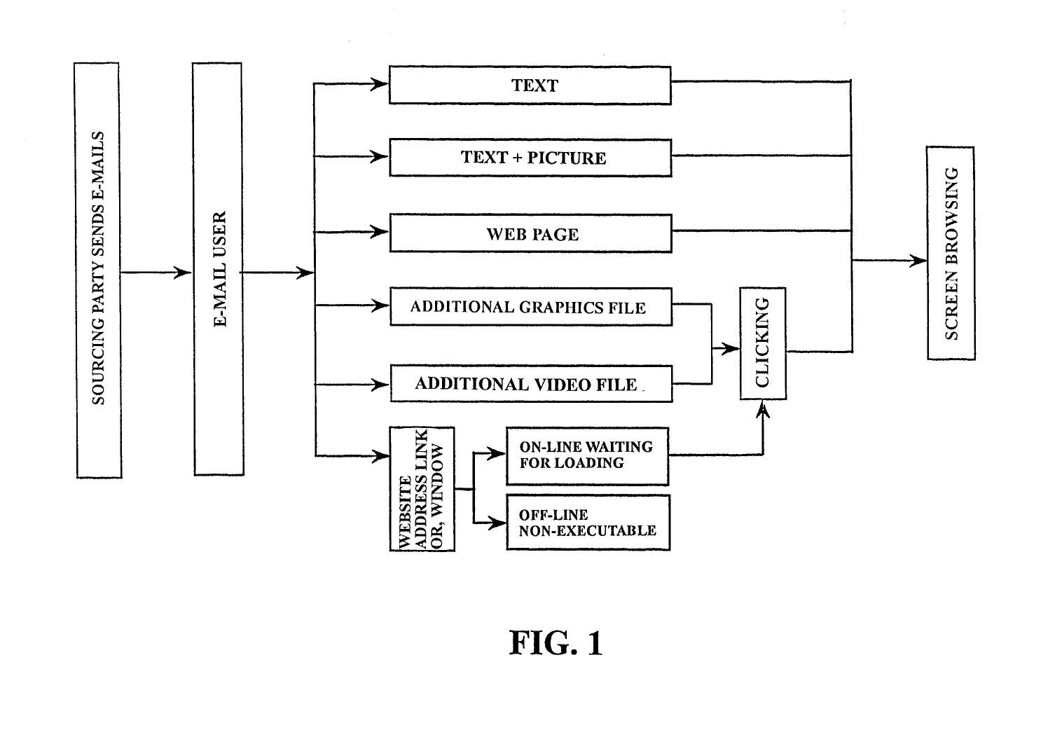

FIG. 2 is a flowchart of the application of the present invention.

### DETAILED DESCRIPTION OF THE PRESENT INVENTION

For the purpose of promoting an understanding of the principles of the invention, reference will now be made to the embodiment illustrated in the drawings. Specific language will be used to describe the sane. It will, nevertheless, be understood that no limitation of the scope of the invention is thereby intended, alterations and further modifications in the illustrated devices, and further applications of the principles of the intention as illustrated herein being contemplated as would normally occur to one skilled in the art to which the invention relates.

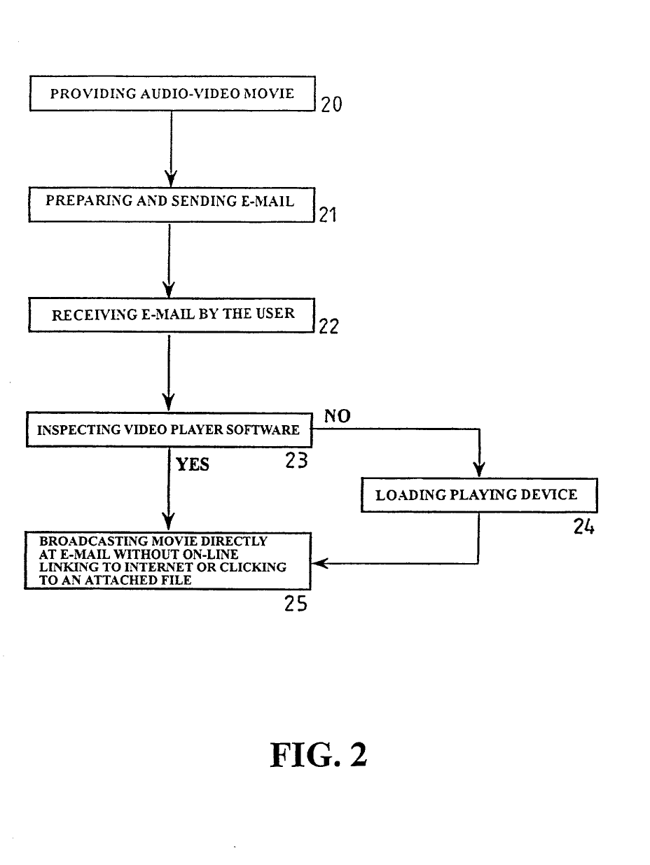

Referring to FIG. 2, there is shown a flowchart of E-mail operation in accordance with the present invention, comprising the steps of

(A) Providing video films 20, wherein the films are provided by corporations, organizations, institutions, schools, professional, or electronic newsletter. The films are produced using CCD, VCR, or cam-Recorder.

(B) Producing the E-mail and sending the E-mail 21. The film are compressed by compression technology into video file of smaller bytes, which can be combined with E-mail texts for sending.

(C) Receiving of the E-mail 22 by the user (recipient). The user at the receiving end receives the E-mails together with the video film files to the mailbox and saved in the computer.

(D) Determining the presence of a video player software 23. If a video player software is not available in the computer of the user, then the video player is automatically downloaded via the Internet Server (24).

And, if a video player software is present, then

(E) Broadcasting the film 25. If the computer has installed with the video player software and if the mailbox receives a video film, the attached video film will be automatically displayed without jumping into another window, without waiting for download of video file from Internet server, or without clicking onto an attachment file.

In accordance with the present invention, when an E-mail with advertisement is received at the first time, the video player software is downloaded once and when the user receives an E-mail with the video film, it will automatically display the video film without clicking onto any additional file or linking on-line for loading. If commercial advertisements, movie previews, teaching lessons, documentary films, news, MTV, etc provided by corporations, organizations, institutions, schools, professionals, or electronic newsletters are received, the films will be displayed automatically without opening an attached file or without linking to the Internet.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made b those skilled in the art without departing in any way from the spirit of the present invention.

I claim:

1. A method of video displaying for E-mails used in video E-mail, allowing an user at the receiving end to increase rate of browsing, comprising the steps of
(a) Providing a video film;
(b) Preparing an E-mail and sending the E-mail to an user (recipient);
(c) Receiving the E-mail by the user (recipient); and
(d) Determining the presence of a video player software in the user's computer, wherein, if the video player software is not available, automatically downloading a video player software from an Internet server, if a video player software is available,
(e) Broadcasting the film within the E-mail format.
